(19) United States
(12) Patent Application Publication
(10) Pub. No.: US 2003/0065915 A1
(43) Pub. Date: Apr. 3, 2003

(54) Method for initializing computer system

(76) Inventors: Chia-Hsing Yu, Taipei (TW); Nai-Shung Chang, Taipei (TW); Ming-Hung Chen, Taipei (TW); Tsung-Yi Lin, Kaohsiung (TW)

Correspondence Address: BEVER HOFFMAN & HARMS, LLP, 2099 GATEWAY PLACE, SUITE 320, SAN JOSE, CA, 951101017

(21) Appl. No.: 10/131,625

(22) Filed: Apr. 23, 2002

(30) Foreign Application Priority Data
Oct. 2, 2001 (TW) 90124317

(51) Int. Cl. G06F 15/177

(52) U.S. Cl. 713/1

(57) ABSTRACT

A method for initializing a computer system employs BIOS to set up a temporary storage area and a temporary setting control flag. When the user alters the configuration settings of the computer system, BIOS saves the new configuration settings into the temporary storage area as temporary configuration settings and sets the temporary setting control flag. When the computer system reboots, BIOS first unsets the temporary setting control flag and initializes the computer system according to the temporary configuration settings in the temporary storage area. If BIOS can successfully initialize the computer system with the temporary configuration settings, the CMOS RAM will be updated with the temporary configuration settings. If BIOS can not successfully initialize the computer system with the temporary configuration settings, in the later initialization of the computer system the BIOS will initialize the computer system in accordance with the configuration settings originally stored in the CMOS RAM.

### FIELD OF THE INVENTION

The present invention is related to a method for initializing a computer system, and more particularly to a method for ensuring the successful initialization of a computer system after the configuration settings of the computer system have been altered.

### BACKGROUND OF THE INVENTION

When a computer system is booting up, in order to normally initialize the computer system, the system basic input-output system (BIOS) would store the configuration information of the computer system that should be preserved permanently, such as the type of the hard disk drive and the size of the system memory, into a complementary-MOS random access memory (commonly referred to as CMOS RAM). The BIOS employs the CMOS RAM to retain the hardware settings of the computer system, such as system clock. When the computer system undergoes an initialization process, the BIOS would check the content of the CMOS RAM to grasp the condition of the computer system, in order that the initial operation of the computer system can be carried out in compliance with the content of the BIOS.

However, when a computer user desires to make alterations to the BIOS menu items, it is very likely to lead the computer system to crash due to the problems of the unmatchable hardware devices in the computer system or an unstable motherboard. For example, when a computer user desires to undertake a procedures for overclocking a central processing unit, the user may use the frequency identification (FID) pins (FID[0:3]) on the motherboard to notify the computer system of the desired frequency multiplier of the central processing unit (or CPU), and use the voltage identification (VID) pins (VID[0:3]) to modulate the working voltage for the central processing unit. When the computer user has altered these hardware settings and rebooted the computer system but encounters crashes, the user has to shut down the computer system first and disassemble the chassis of the computer system, and then load the default configuration settings to enable the BIOS to boot the computer system with the default configuration settings. Nevertheless, the foregoing procedures are quite unfriendly with respect to the operation of the computer. For a computer user who is raw to the hardware circuits of the computer system, it might become a knotty job.

### SUMMARY OF THE INVENTION

In order to solve the foregoing problems encountered by the prior art, the present invention addresses a method for initializing a computer system. The method for initializing a computer system of the present invention makes use of the BIOS to set up a temporary storage area and a temporary setting control flag, wherein the temporary storage area is used to retain the temporary configuration settings made by the computer user. The temporary setting control flag is a one-bit data structure, and is used to indicate whether there are any temporary configuration settings in the temporary storage area. When the user has altered the configuration settings of the computer system, BIOS would treat these new configuration settings as temporary configuration settings and put them in the temporary storage area. When the computer system is rebooting, BIOS will first unset the temporary setting control flag and initialize the computer system with the temporary configuration settings in the temporary storage area. If the BIOS is able to successfully initialize the computer system with the temporary configuration settings, the CMOS RAM will be updated with the temporary configuration settings. If BIOS is unable to successfully initialize the computer system with the temporary configuration settings, BIOS would initialize the computer system with the original configuration settings stored in the CMOS RAM as the computer system reboots.

Now the foregoing and other features and advantages of the present invention will be more clearly understood through the following descriptions with reference to the drawings, wherein:

### BRIEF DESCRIPTION OF THE DRAWINGS

FIG. 1 depicts a functional block diagram of the computer system of the present invention; and

FIG. 2 depicts a flowchart illustrating the method for initiating the computer system according to a preferred embodiment of the present invention.

### DETAILED DESCRIPTION OF THE PREFERRED EMBODIMENT

The method for initializing the computer system according to the present invention will be fully described with reference to the following preferred embodiment. It is to be noted that the following descriptions of the preferred embodiment of the present invention are presented herein for the purpose of illustration and description only. It is not intended to be exhaustive or not to be limited to the precise form disclosed.

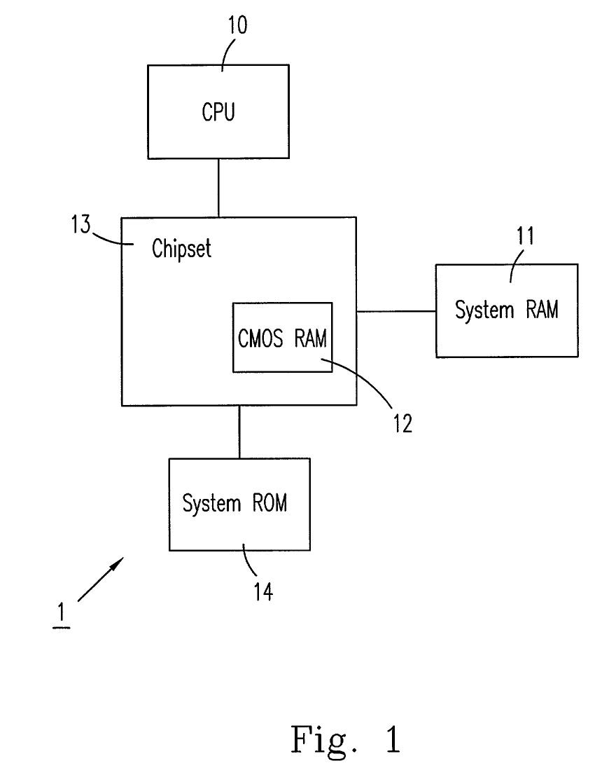

In a preferred embodiment of the present invention, the present invention is concretized by the functional block diagram of the computer system 1 as illustrated in FIG. 1. The computer system 1 includes a central processing unit (or CPU) 10, such as an Intel Pentium processor or an AMD Athlon processor. The computer system 1 also includes a chipset 13, a system RAM 11 and a system ROM 14. Furthermore, the chipset 13 is integrated with a CMOS RAM 12. The CMOS RAM 12 is used to retain the configuration information of the computer system, and is powered by a backup battery (not shown). The system ROM 14 is also provided in the computer system 1 and contains BIOS codes for initializing the computer system 1 and loading the operating system such as Microsoft Windows 98 into the system RAM 11. As will be described in detail through the following, a temporary setting control flag which is a one-bit data structure will be set up in the CMOS RAM 12. The temporary setting control flag is used to indicate whether the user has altered the configuration settings of the computer system 1 when the computer system is booting up. When the temporary setting control flag is set, it indicates that there are temporary configuration settings in a temporary storage area, and BIOS will boot the computer system in accordance with the temporary configuration settings in the temporary storage area.

Various components in the computer system 1 are coupled together by the chipset 13, which can offer a channel for transmitting control signals in addition to address/data signals. The chipset 13 may comprise a north bridge chipset or a south bridge chipset (not shown).

As can be known by a person skilled in the art of computer technology, the chip enable circuit of the chipset 13 (not shown) in the computer system 1 will send out a ROM selection signal (ROMSEL#) to enable the system ROM 14 and activate the operation of BIOS. BIOS will prompt the user with a BIOS setup menu by way of depressing a hot key (for example, the Delete key). When the user enters the BIOS setup menu, the configuration settings of all kinds of hardware components of the computer system 1 can be altered at will by the user, for example, the operation frequency of the system RAM 11 and the frequency multiplier and external frequency of the CPU 10. When the user has entered the alterations to the configuration settings of the computer system 1 and decided to save these new configuration settings, BIOS will save these new configuration settings directly into the CMOS RAM 12 to bring these new configuration settings into effect when rebooting the computer system 1. BIOS will initialize the hardware configuration and executes hardware tests in accordance with the hardware information stored in the CMOS RAM 12.

As discussed above, if the user has altered the configuration settings of the computer system 1 and rebooted the computer system 1 to bring these new configuration settings into effect, it is likely to lead the computer system to crash. On this condition, the user has to disassemble the chassis of the computer system 1 and flush the hardware configuration information in the CMOS RAM 12, and load the default configuration settings to enable the BIOS to configure the hardware devices of the computer system 1 in accordance with the hardware configuration settings in the CMOS RAM 12 in the later initialization of the computer system 1. The present invention provides a simple and convenient knack for initializing the computer system 1, which takes advantage of the BIOS to assign an unused memory space to serve as a temporary storage area for storing the altered configuration settings made by the user (these altered configuration settings will be defined as temporary configuration settings). In a preferred embodiment of the present invention, a segment of the unused memory space in the 256-Kilobytes CMOS RAM 12 is set up as a temporary storage area for storing the temporary configuration settings. In addition, a temporary setting control flag is set up in an unused memory location in the CMOS RAM 12, which is a one-bit data flag for indicating whether there are temporary configuration settings in the temporary storage area.

According to a preferred embodiment of the present invention, when the user has altered the configuration settings of the computer system 1 by virtue of the BIOS setup menu, BIOS will not directly save these new configuration settings into the CMOS RAM 12. Instead, BIOS will assign a memory space of several kilobytes to be a temporary storage area, and define these new configuration settings as temporary configuration settings and save them into the temporary storage area. In the mean time, BIOS will set up a temporary setting control flag to indicate whether there are temporary configuration settings in the CMOS RAM 12. The function of the temporary setting control flag is to provide the BIOS with an indication of whether there are temporary configuration settings in the CMOS RAM 12. If the BIOS accesses the temporary setting control flag and found that the temporary setting control flag is set, BIOS will initialize the computer system 1 in accordance with the temporary configuration settings in the temporary storage area. If the BIOS access the temporary setting control flag and found that the temporary setting control flag is unset, BIOS will initialize the computer system 1 in accordance with the original configuration settings stored in the CMOS RAM 12. When the user has altered the configuration settings of the computer system 1, BIOS will set the temporary setting control flag first and when the computer system is rebooting, the BIOS will unset the temporary setting control flag first and initialize the computer system 1 in accordance with the temporary configuration settings in the temporary storage area. If BIOS can successfully initialize the computer system in accordance with the temporary configuration settings in the temporary storage area, the CMOS RAM 12 will be updated with the temporary configuration settings to bring the temporary configuration settings into effect eternally. If a failure is encountered when the BIOS is initializing the computer system 1 with the temporary configuration settings in the temporary storage area, that is, the computer system 1 is hung up, BIOS will proceed with the initialization process for the computer system 1 in accordance with the original configuration information stored in the CMOS RAM 12 when the computer system 1 is rebooting.

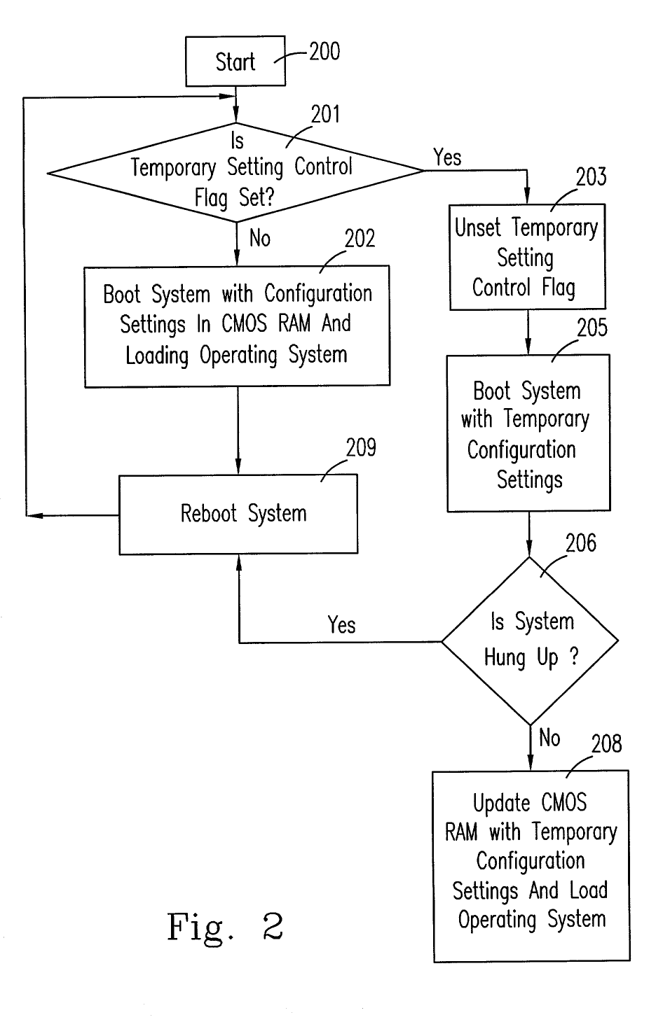

FIG. 2 depicts a flowchart illustrating the initialization process for the computer system according to a preferred embodiment of the present invention. Starting from step 200, the turn-on or reset operation of the computer system will cause the computer system to undergo an initialization process. At step 201, BIOS will check whether or not the temporary setting control flag is set. If the temporary setting control flag is set, it indicates that there are temporary configuration settings in the temporary storage area, and the initialization process continues with step 203 to unset the temporary setting control flag. If the temporary setting control flag is unset, it indicates that hardware settings contained in BIOS are not altered, the initialization process continues with step 202 and the BIOS continues with the booting operation in accordance with the original configuration settings stored in the CMOS RAM until the operating system is loaded.

At step 205, BIOS will initialize the computer system in accordance with the temporary configuration settings. At decision 206, BIOS will determine whether the computer system is hung up. If the computer system is not hung up, at step 208 BIOS will update the CMOS RAM with these temporary configuration settings, in order to bring these temporary configuration settings into effect and load the operating system. If the computer system is hung up, the initialization process continues with step 209 to reboot the computer system and continues with step 201 to proceed with the next booting operation. Because the temporary setting control flag has been unset, in the later booting operation of the computer system BIOS can initialize the computer system in accordance with the original configuration settings stored in the CMOS RAM until the operating system is loaded.

The method for initializing the computer system according to the present invention is peculiarized by that when the user alters the configuration settings of the computer system, BIOS will not directly save the new configuration settings into the CMOS RAM, but saves them in a temporary storage area. If BIOS can successfully boot the computer system with the new configuration settings, the CMOS RAM will be updated with the new configuration settings. Otherwise, if BIOS can not successfully boot the computer system with the new configuration settings, the computer system will be initialized with the original configuration settings stored in the CMOS RAM. When it is intended to alter the configuration settings of the computer system, the user may verify in advance whether the altered configuration setting can permit the computer system to boot up successfully. If the computer system can not be initialized after the configuration settings of the computer system have been altered, BIOS will automatically reset to initialize the computer system with the original configuration settings that can permit the computer system to boot up successfully, so as to eliminate the inconvenience and annoyance to a computer user arising from the computer system validation procedure. It is to be noted that the method of the present invention will be effective only when the user has altered the content of the CMOS RAM. If the user does not alter the content of the CMOS RAM, the computer system can successfully boot up until the operating system is loaded in the light of the present invention.

Although the present invention has been described and illustrated in detail, it is to be clearly understood that the same is by the way of illustration and example only and is not to be taken by way of limitation, the spirit and scope of the present invention being limited only by the terms of the appended claims.

What is claimed is:

1. A method for initializing a computer system comprising the steps of:
checking a control flag;
if said control flag is set, unsetting said control flag;
initializing said computer system by a basic input-output system in accordance with a temporary configuration setting stored in a first memory device;
if said computer system is normally operating, saving said temporary configuration setting into a second memory device as a configuration setting of said computer system;
if said control flag is unset, initializing said computer system by said basic input-output system in accordance with a configuration setting originally stored in said second memory device.

2. The method according to claim 1 wherein said first memory device is identical to said second memory device.

3. The method according to claim 2 wherein both said first memory device and said second memory device comprise a complementary-MOS random access memory.

4. The method according to claim 1 wherein a predetermined location of second memory device which has a plurality of memory locations contains said control flag indicating whether said first memory device contains said temporary setting.

5. The method according to claim 1 wherein said control flag is a one-bit data structure.

6. The method according to claim 1 further comprising the steps of:
if said computer system is hung up, rebooting said computer system; and
if said control flag is unset, initializing said computer system by said basic input-output system in accordance with a configuration setting originally stored in said second memory device.

7. A method for initializing a computer system comprising the steps of:
checking a control flag;
if said control flag is set, unsetting said control flag;
initializing said computer system by a basic input-output system in accordance with a temporary configuration setting stored in a first memory device;
if said computer system is normally operating, saving said temporary configuration setting into a second memory device as a configuration setting of said computer system;
if said control flag is unset, initializing said computer system by said basic input-output system in accordance with a configuration setting originally stored in a second memory device;
if said computer system is hung up, rebooting said computer system; and
if said control flag is unset, initializing said computer system by said basic input-output system in accordance with a configuration setting originally stored in said second memory device.

8. The method according to claim 7 wherein said first memory device is identical to said second memory device.

9. The method according to claim 8 wherein both said first memory device and said second memory device comprise a complementary-MOS random access memory.

10. The method according to claim 7 wherein a predetermined location of second memory device which has a plurality of memory locations contains said control flag indicating whether said first memory device contains said temporary setting.

11. The method according to claim 7 wherein said control flag is a one-bit data structure.
